(19) United States
(12) Patent Application Publication
(10) Pub. No.: US 2026/0212532 A1
(43) Pub. Date: Jul. 23, 2026

(54) SYSTEM FOR DETECTING COLOR BANDING AND A METHOD THEREOF

(71) Applicant: Interra Systems, Inc., Cupertino, CA (US)

(72) Inventors: PYAAR SINGH, Sirsa (IN); SHEKHAR MADNANI, Noida (IN)

(73) Assignee: Interra Systems, Inc., Cupertino, CA (US)

(21) Appl. No.: 19/035,514

(22) Filed: Jan. 23, 2025

(51) Int. Cl. G06T 7/90; G06T 5/40; G06T 5/73; G06T 5/92; G06T 7/11; G06T 7/12

(52) U.S. Cl. CPC G06T 7/90; G06T 5/40; G06T 5/73; G06T 5/92; G06T 7/11; G06T 7/12; G06T 2207/10024; G06T 2207/20192

(57) ABSTRACT

A system for detecting color banding comprises an image capturing device to capture an input image and at least one processor having at least one memory. The at least one processor is configured to determine one or more parameters of the input image, determine a plurality of absolute pixel gradients in X-axis direction and Y-axis direction of the input image based at least on the one or more parameters, generate a buffer comprising maximum absolute pixel gradients, create a histogram using the buffer, determine probability distribution function (PDF) using the histogram, determine cumulative distribution function (CDF) using the PDF, determine dynamic threshold (DT) value using the CDF, identify a plurality of potential color banding areas based on the dynamic threshold value, determine a plurality of contours within the plurality of potential color banding areas and determine a color banding index based at least on the plurality of contours.

### TECHNOLOGICAL FIELD

Example embodiments of the present disclosure generally relates to color banding, and more particularly relates to a system and a method for detecting and quantifying color banding in digital images.

### BACKGROUND

Color banding is a subtle and often undesirable artifact that occurs in digital images and videos. It is a form of posterization, where smooth gradation of colors is disrupted, causing noticeable bands of color to appear. This effect arises when the color of each pixel in an image is rounded to the nearest available digital color level, leading to a loss of smooth transitions between adjacent colors. In standard 24-bit color modes, each pixel is typically represented by 8 bits per channel, which is generally sufficient to render images within standardized color spaces such as ITU-R BT. 709 or sRGB, etc. These color spaces are widely used in television, computer displays, and other digital media to ensure consistent and accurate color reproduction. However, the human eye is sensitive to even slight variations in color levels, particularly when there is a sharp transition between two adjacent color areas. This sensitivity becomes more apparent in images or videos with gradual gradients, such as those depicting sunsets, dawns, or clear blue skies, where the limited number of color levels can lead to visible color banding. Such problem of color banding is exacerbated in images with fewer bits per pixel (BPP) such as those with 16-256 colors (4-8 BPP). In these cases, the reduced number of available shades results in larger differences between adjacent color levels, making the color banding more prominent. Color Banding also occurs due to lossy image or video compression, low-bit rate, camera and object motion, DE-interlacing, zooming and super-resolution. Further, color banding cannot be removed by blurring the images.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a system for detecting color banding is disclosed. The system comprises an image capturing device configured to capture an input image and at least one processor having at least one memory and communicatively coupled to the image capturing device. Further, the at least one processor is configured to determine one or more parameters of the input image captured by the image capturing device, determine a plurality of absolute pixel gradients in an X-axis direction and a Y-axis direction of the input image based at least on the determined one or more parameters including at least an image size and a plurality of pixel values, generate a buffer comprising maximum absolute pixel gradients determined using the plurality of absolute pixel gradients in the X-axis direction and the Y-axis direction, create a histogram based at least on the generated buffer, determine a probability distribution function (PDF) based at least on the histogram, determine a cumulative distribution function (CDF) based at least on the determined PDF, determine a dynamic threshold value based at least on the determined CDF, identify a plurality of potential color banding areas based at least on the determined dynamic threshold value, determine a plurality of contours within the plurality of potential color banding areas based at least on one or more conditions and determine a color banding index for the input image based at least on the plurality of contours determined.

In some embodiments, the at least one processor is further configured to remove plurality of boundary black bars from the input image. Further, the at least one processor is configured to determine the plurality of absolute pixel gradients in the X-axis direction and the Y-axis direction.

In some embodiments, the plurality of contours corresponds to a plurality of acceptable parent contours and a plurality of acceptable sub-contours. Further, the at least one processor is configured to eliminate one or more of the plurality of parent contours based at least on the one or more conditions to determine the plurality of acceptable parent contours, determine one or more of the plurality of acceptable sub-contours corresponding to a single pixel value with respect to the input image, determine a buffer using the plurality of acceptable parent contours and the plurality of acceptable sub-contours and eliminate one or more of the plurality of acceptable parent contours and the plurality of acceptable sub-contours with less than a threshold pixel area to obtain a plurality of color banding areas.

In some embodiments, the one or more conditions correspond to a contour area threshold, a pixel gradient threshold, unique pixel value count threshold, plurality of internal pixel gradients of the plurality of contours and plurality of external pixel gradient of the plurality of contours.

In some embodiments, the at least one processor is configured to employ a morphological operation on plurality of absolute pixel gradients in an X-axis direction and a Y-axis direction, the morphological operation comprises at least dilation. In some embodiments, the at least one processor is configured to determine a maximum of the dilated gradients of the plurality of absolute pixel gradients in the X-axis direction and the Y-axis direction.

In some embodiments, the color banding index is based at least on a plurality of acceptable parent contours combined and maximum of the dilated gradients of the plurality of absolute pixel gradients in the X-axis direction and the Y-axis direction.

In another example embodiment, a method is disclosed. The method comprising steps of capturing, via an image capturing device, an input image, determining, via at least one processor having at least one memory and communicatively coupled to the image capturing device, one or more parameters of the input image, determining, via the at least one processor, plurality of absolute pixel gradients in an X-axis direction and a Y-axis direction of the input image based at least one the one or more parameters, generating, via the at least one processor, a buffer comprising maximum absolute pixel gradients between the plurality of absolute pixel gradients in the X-axis direction and the Y-axis direction, creating, via the at least one processor, a histogram based at least on the buffer, determining, via the at least one processor, a probability distribution function (PDF) based at least on the histogram, determining, via the at least one processor, a cumulative distribution function (CDF) based at least on the probability distribution function (PDF), determining, via the at least one processor, a dynamic threshold value based at least on the determined CDF, identifying, via the at least one processor, a plurality of potential color banding areas based at least on the determined dynamic threshold value, determining, via the at least one processor, a plurality of contours within the plurality of potential color banding areas based at least on one or more conditions and determining, via the at least one processor, a color banding index for the input image based at least on the plurality of contours determined.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of a system for detecting color banding in accordance with an example embodiment of the present disclosure;

FIG. 2A illustrates pictorial representation of a plurality of pixel values in an input image in accordance with an example embodiment of the present disclosure;

FIG. 2B illustrates a table as a plurality of absolute pixel value gradients in X-axis direction computed from a table of plurality of pixel values in an input image in accordance with an example embodiment of the present disclosure;

FIG. 2C illustrates a table as a plurality of absolute pixel value gradients in Y axis direction computed from a table of plurality of pixel values in an input image in accordance with an example embodiment of the present disclosure;

FIG. 2D illustrates a table showing a buffer computed as maximum of plurality of absolute pixel value gradients in X-axis direction and Y-axis direction in accordance with an example embodiment of the present disclosure;

FIG. 2E illustrates a set of tables showing plurality of pixel values as input to determine the plurality of absolute pixel value gradients in X-axis direction and the plurality of absolute pixel value gradients in Y-axis direction in accordance with another example embodiment of the present disclosure;

FIG. 2F illustrates a set of tables showing the plurality of absolute pixel value gradients in X-axis direction, the plurality of absolute pixel value gradients in Y-axis direction and a buffer computed using the plurality of absolute pixel value gradients in X-axis direction and Y-axis direction in accordance with another example embodiment of the present disclosure;

FIG. 2G illustrates a table showing an example buffer in accordance with another example embodiment of the present disclosure;

FIG. 2H illustrates a histogram plotted based on absolute pixel value gradient and pixel count determined using the example buffer in accordance with an example embodiment of the present disclosure;

FIG. 2I illustrates a probability distribution function (PDF) in accordance with an example embodiment of the present disclosure;

FIG. 2J illustrates a cumulative distribution function (CDF) in accordance with an example embodiment of the present disclosure;

FIG. 3A illustrates equations of a Cumulative Distribution Function (CDF) in accordance with an example embodiment of the present disclosure;

FIG. 3B illustrates an output of the CDF constructed from PDF as input in accordance with an example embodiment of the present disclosure;

FIG. 4A illustrates a positive thresholding method and a negative thresholding method in accordance with an example embodiment of the present disclosure;

FIG. 4B illustrates an output of the positive thresholding method in accordance with an example embodiment of the present disclosure;

FIGS. 5A-5B illustrate morphological operations in accordance with an example embodiment of the present disclosure;

FIGS. 6A-6B illustrate a structuring element in accordance with an example embodiment of the present disclosure;

FIG. 7A illustrates a plurality of contours within the plurality of potential color banding areas in accordance with an example embodiment of the present disclosure;

FIGS. 7B-7C illustrate a plurality of acceptable parent contours and sub-contours within the plurality of potential color banding areas in accordance with an example embodiment of the present disclosure; and

FIG. 8 illustrates a method for detecting color banding in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a system for detecting color banding. Embodiments may comprise an image capturing device, at least one processor and at least one memory. Embodiments may be configured to capture an input image. Embodiments may be configured to determine the one or more parameters of the input image and determine plurality of absolute pixel gradients in an X-axis direction and a Y-axis direction of the input image. Embodiments may be configured to generate a buffer including maximum of the plurality of absolute pixel gradients in the X-direction buffer and the Y-direction buffer, based on the one or more parameters of the input image, create a histogram based at least on the buffer, determine a probability distribution function (PDF) based at least on the histogram, determine a cumulative distribution function (CDF) based at least on the PDF, determine a dynamic threshold value based at least on the CDF, determine plurality of potential color banding areas based on the dynamic threshold value, determine a plurality of contours within the plurality of potential color banding areas based on one or more conditions and determine a color banding index for the input image using the plurality of contours.

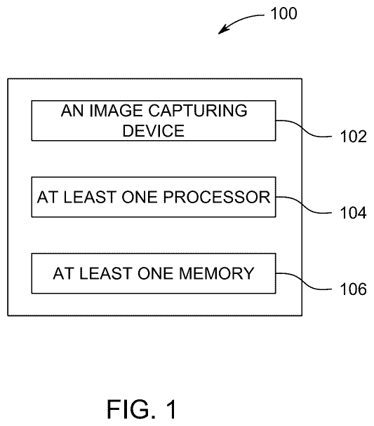

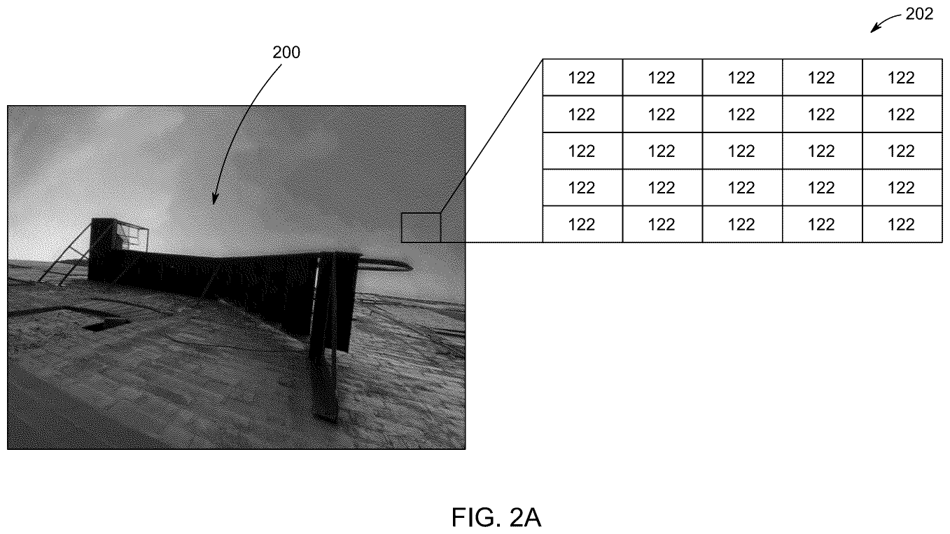

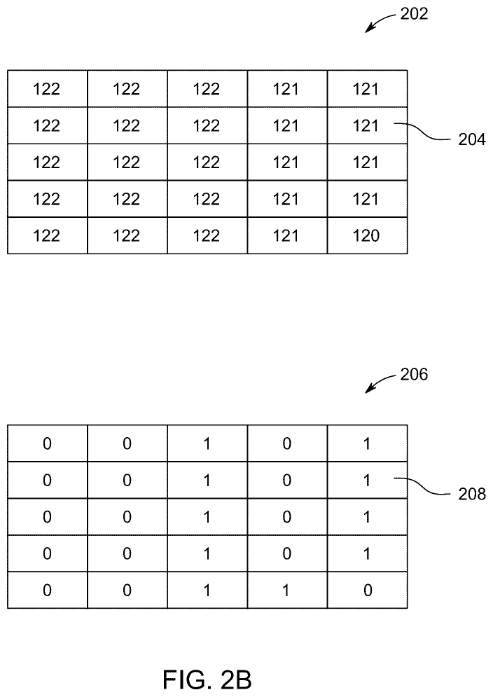

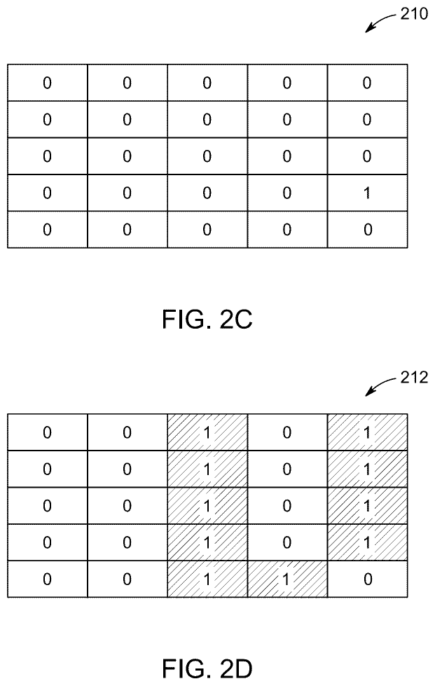

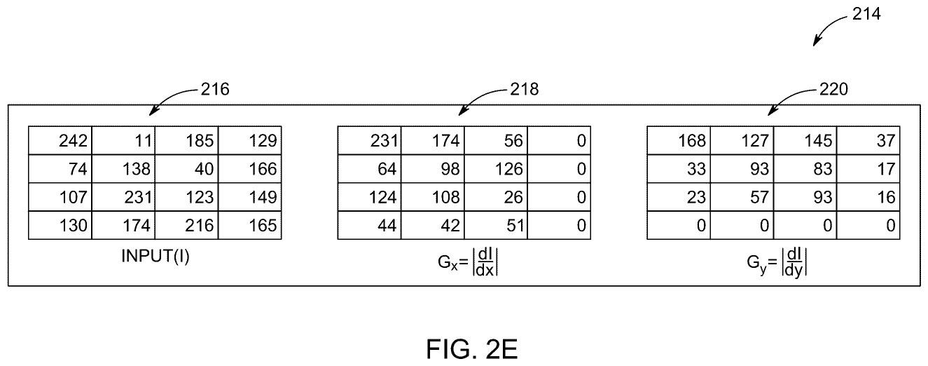

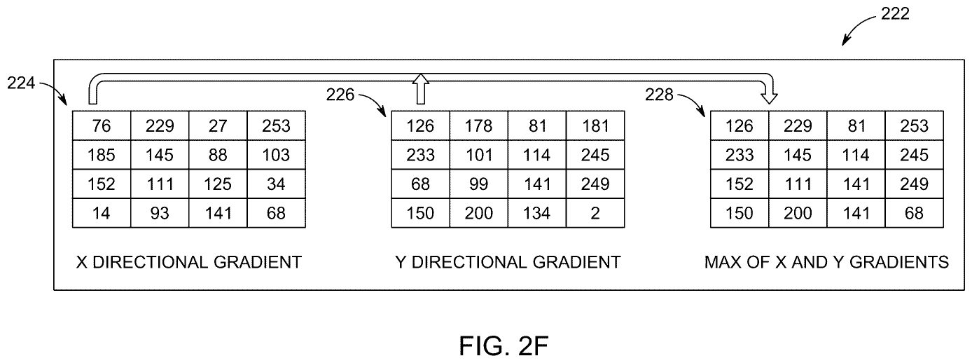

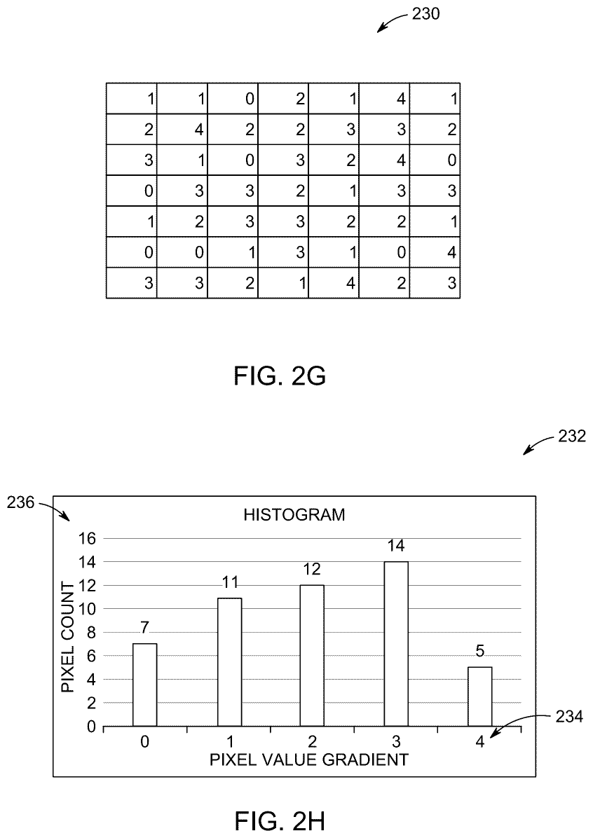

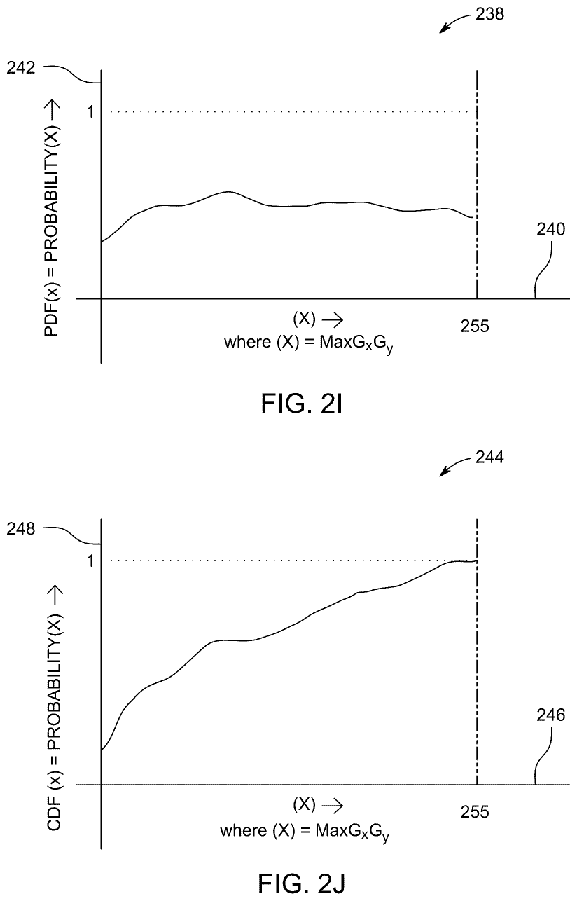

FIG. 1 illustrates a block diagram of a system 100 for detecting color banding, in accordance with an example embodiment of the present disclosure. FIG. 2A illustrates pictorial representation of a plurality of pixel values in an input image, in accordance with an example embodiment of the present disclosure. FIG. 2B illustrates a table 206 as a plurality of absolute pixel value gradients in X-axis direction 208 computed from a table 202 of plurality of pixel values 204 in an input image, in accordance with an example embodiment of the present disclosure. FIG. 2C illustrates a table 210 as a plurality of absolute pixel value gradients in Y axis direction computed from the table 202 of plurality of pixel values 204 in an input image, in accordance with an example embodiment of the present disclosure. FIG. 2D illustrates a table 212 showing a buffer computed as maximum of plurality of absolute pixel value gradients in X-axis direction and Y-axis direction, in accordance with an example embodiment of the present disclosure. FIG. 2E illustrates a set of tables 214 showing plurality of pixel values as input to determine the plurality of absolute pixel value gradients in X-axis direction and the plurality of absolute pixel value gradients in Y-axis direction, in accordance with another example embodiment of the present disclosure. FIG. 2F illustrates a set of tables 222 showing the plurality of absolute pixel value gradients in X-axis direction, the plurality of absolute pixel value gradients in Y-axis direction and a buffer computed using the plurality of absolute pixel value gradients in X-axis direction and Y-axis direction, in accordance with another example embodiment of the present disclosure. FIG. 2G illustrates a table 230 showing an example buffer in accordance with another example embodiment of the present disclosure. FIG. 2H illustrates a histogram 232 plotted based on absolute pixel value gradient and pixel count determined using the example buffer in accordance with an example embodiment of the present disclosure. FIG. 2I illustrates a probability distribution function (PDF) in accordance with an example embodiment of the present disclosure. FIG. 2J illustrates a cumulative distribution function (CDF) in accordance with an example embodiment of the present disclosure.

In some embodiments, the system 100 for detecting the color banding may comprise an image capturing device 102 configured to capture an input image. In an example, the input image may be a digital image. In an example, the input image may include subtle form of posterization. The posterization corresponds to process of reducing the number of distinct colors or shades in the input image, creating abrupt changes in tone or color of the input image instead of smooth gradients. In an example, the abrupt changes may correspond to color banding in areas of color transition. In some embodiments, the color banding may occur due to low bit depth, lossy compression or insufficient color contrast of the input image.

In some embodiments, the system 100 further comprises at least one processor 104 having at least one memory 106. In some embodiments, the at least one memory 106 may be configured to store one or more parameters of the input image. In some embodiments, the one or more parameters may correspond to an image size and a plurality of pixel values. In an example, the plurality of pixel values corresponds to numerical representations of intensity or color at each point in the input image. In an example, an instance the input image is grayscale image, the plurality of pixel values corresponds to numerical representations of intensity at each point in the input image. In another example, an instance the input image is color image, the plurality of pixel values corresponds to numerical representations of color at each point in the input image.

In an example, the input image may be an 8-bit image with the plurality of pixel values ranging from 0 to 255. In an example, for grayscale image, 0 represents black, 255 represents white, and the plurality of pixel values in between 0 and 255 represents varying shades of gray. In another example, for color image (e.g. Red, Green, Blue (RGB)) each color channel i.e. Red, Green, Blue is represented by 8 bits, allowing for 256 pixel values per channel. The combination of Red, Green and Blue channels allows for over 16 million possible pixel values i.e. 16 million possible colors (256×256×256).

In some embodiments, the at least one processor 104 may include suitable logic, circuitry, and/or interfaces that are operable to execute one or more instructions stored in the at least one memory 106 to perform predetermined operations. The at least one processor 104 may be configured to execute one or more computer-readable program instructions, such as program instructions to carry out any of the functions described in this description. Further, the at least one processor 104 may be implemented using one or more processor technologies known in the art. Examples of the at least one processor 104 may include, but are not limited to, one or more general purpose processors and/or one or more special purpose processors (e.g., digital signal processors or Field Programmable Gate Array (FPGA) processor).

In some embodiments, the at least one memory 106 may be configured to store the one or more instructions that may cause the at least one processor 104 to perform one or more operations. It is apparent to a person with ordinary skill in the art that the one or more instructions stored in the at least one memory 106 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

It will be apparent to one skilled in the art that above-mentioned components of the system 100 have been provided only for illustration purposes, without departing from the scope of the disclosure.

In some embodiments, the at least one processor 104 may be configured to determine one or more parameters of the input image captured by the image capturing device 102. In some embodiments, the one or more parameters of the input image comprises at least an image size and a plurality of pixel values. In some embodiments, the at least one processor 104 may be configured to preprocess the input image to remove plurality of black boundary bars from the input image. In some embodiments, the input image may include the plurality of black boundary bars that may be present due to formatting and aspect ratio adjustments of the input image. In some embodiments, the plurality of black boundary bars may be artefacts and hence removed from the input image. In an example, the at least one processor 104 will not consider the plurality of pixel values corresponding to the black boundary bars of the input image.

In some embodiments, the at least one processor 104 may be configured to determine a plurality of absolute pixel gradients based at least on the determine one or more parameters. In some embodiments, the at least one processor 104 may compute plurality of absolute pixel gradients in an X-axis direction and a Y-axis direction of the input image. The absolute pixel gradients refer to magnitudes of rate of change in intensity or color of plurality of pixels between one or more neighboring pixels in the input image. In an example, the input image may be a two-dimensional digital image. The input image may correspond to plurality of absolute pixel gradients horizontally (an X-axis direction) and vertically (a Y-axis direction). In an example, the plurality of absolute pixel gradients in the X-axis direction

$$( \frac{dI}{dx} )$$

may be calculated as difference between intensity of a pixel and the pixel to its right. The plurality of absolute pixel gradients in the Y-axis direction

$$( \frac{dI}{dy} )$$

may be calculated as difference between intensity of a pixel gradients in the Y-axis.

In an example, ‘I’ denotes the plurality of pixel values of the input image arranged in a mathematical representation e.g. a matrix. Further, at least one of the plurality of pixel gradients is denoted by ‘∇I’. Further, the at least one of the plurality of pixel gradients is defined by

$$[ \vec{∇ I} = {[ \frac{dI}{dx} , \frac{dI}{dy} ]}^{T} ] ,$$

wherein ‘∇I’ is a two-dimensional column vector denoted by R². Further, in another example, the input image may be a discrete image,

$$\frac{dI}{dx} = I ( x + 1 , y ) - I ( x , y ) and \frac{dI}{dy} = I ( x , y + 1 ) - I ( x , y ) ,$$

wherein X and Y are horizontal and vertical coordinates in the input image with (0,0) centered at top left corner of the input image and Y coordinate increasing downwards from the top left corner of the input image. Further, in some embodiments, the plurality of absolute pixel gradients may be computed using an absolute function defined as y=|x|, which is further defined as y={x, for x ≥0} or y={−x, for x<0). Thus, value of ‘y’ is always a positive value representing the plurality of absolute pixel gradient.

In some embodiments, one or more boundary conditions may be implemented on the plurality of absolute pixel gradients of the X-direction buffer and the plurality of absolute pixel gradients of the Y-direction buffer. In an example, to get first element in the X-direction buffer, the at least on processor 104 may compute “abs (242−11)=231” as shown in FIG. 2E, but to get the plurality of absolute pixel gradients of the X-direction buffer element corresponding to first row and last column, “abs (129−?)=?” is not available. So, to get the X-direction buffer, the last column may be considered as zero. To get first element in the Y-direction buffer the at least one processor 104 may compute “abs (242−74)=168”, but to get the plurality of absolute pixel gradients of the Y-direction buffer, the element corresponding to first column and last row, “abs (130−?)=?” is not available. So, to get the Y-direction buffer, the last row considered as zero.

In an example, an input image is shown in FIG. 2A having a plurality of color banding areas 200. In correspondence to the plurality of color banding areas 200, the plurality of pixel values is shown in table 202. In an example, a portion of the input image may be represented as a two-dimensional array shown in the table 202. In an example, the table 202 of FIG. 2A shows five rows and five columns of the two-dimensional array. The table 202 may be an input table. In an example, the plurality of pixel values 204 of the input image is shown in the form of two-dimensional array in the table 202. Each of the plurality of pixel values in the table 202 correspond to numerical representations of intensity or color at each point in the input image. In some embodiments, using the plurality of pixel values of the table 202, the at least one processor 104 may determine the plurality of absolute pixel gradients (shown as values 208 of the table 206) in X-axis direction

$$( \frac{dI}{dx}$$

shown as values 208 in the table 206) and the plurality of absolute pixel gradients in Y-axis direction

$$( \frac{dI}{dy}$$

shown in table 210) or the input image. As shown in FIG. 2B-2C, the plurality of absolute pixel gradients in the X axis direction as X direction buffer is shown in the table 206 and the plurality of absolute pixel gradients in the Y direction as Y axis direction buffer is shown in table 210.

In an example, as explained previously, the plurality of absolute pixel gradient in the X axis direction shown in the table 206, is computed as absolute difference between the pixel values of the table 202 in the X-axis direction, depicted as the formula:

$${G}_{x} = \frac{dI}{dx} = \vert I ( x + 1 , y ) - I ( x , y ) \vert$$

Further, the plurality of absolute pixel gradient in the Y axis direction shown in the table 210, is computed as absolute difference between the pixel values of the table 202 in the Y-axis direction, depicted as the formula

$${G}_{y} = \frac{dI}{dy} = \vert I ( x , y + 1 ) - I ( x , y ) \vert .$$

In some embodiments, the at least one processor 104 may generate a buffer (shown in table 212) determined as maximum of Gₓ and G_{y}. In some embodiments, the at least one processor 104 may generate the buffer (shown in table 212) via the formula MaxGₓG_{y}=Max (Gₓ, G_{y}), as shown in FIG. 2D.

In another example, as shown by set of tables 214 in FIG. 2E, the table 216 may correspond to the input table. In an example, the table 216 is extension of the table 202 representing the plurality of pixel values. In some embodiments, the at least one processor 104 may generate the buffer as shown in a table 222 (shown in FIG. 2F) comprising maximum of the plurality of absolute pixel gradients based on the one or more parameters of the input image. In some embodiments, the one or more parameters of the input image may include the image size and the plurality of pixel values. In an example, the buffer (table 228) may correspond to the maximum of the plurality of absolute pixel gradients in the X-axis direction and the plurality of absolute pixel gradients in the Y-axis direction. Further, the table 218 and the table 220 are extension of the table 206 and the table 210, respectively.

In an example, as shown in FIG. 2F, the table 224 includes plurality of absolute pixel gradients (values) in the X-axis direction, the table 226 includes plurality of absolute pixel gradients (values) in the Y-axis direction and the table 228 includes maximum of the plurality of absolute pixel gradients in the X-axis direction and the plurality of absolute pixel gradients (values) in the Y-axis direction. In an example, the absolute pixel gradient values of the table 228 is calculated using the absolute pixel gradient values in the X-axis direction and Y-axis direction respectively. Further, the absolute pixel gradient values of the table 228 are calculated using the absolute pixel gradient values in the X-axis and Y-axis direction respectively. The table 228 (FIG. 2F) is extension of the table 212 (FIG. 2D), representing the maximum absolute pixel value gradients buffer in the X-axis direction and the Y-axis direction of the same input image 200.

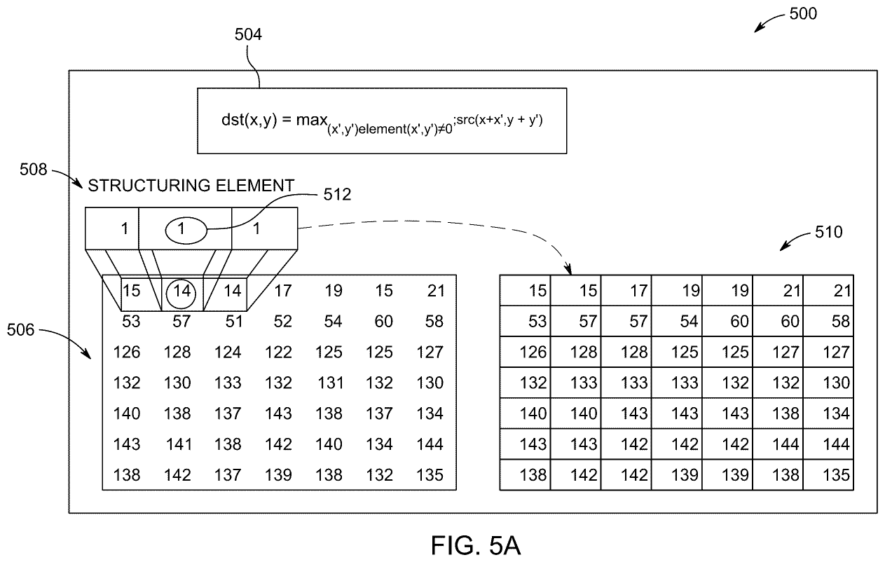

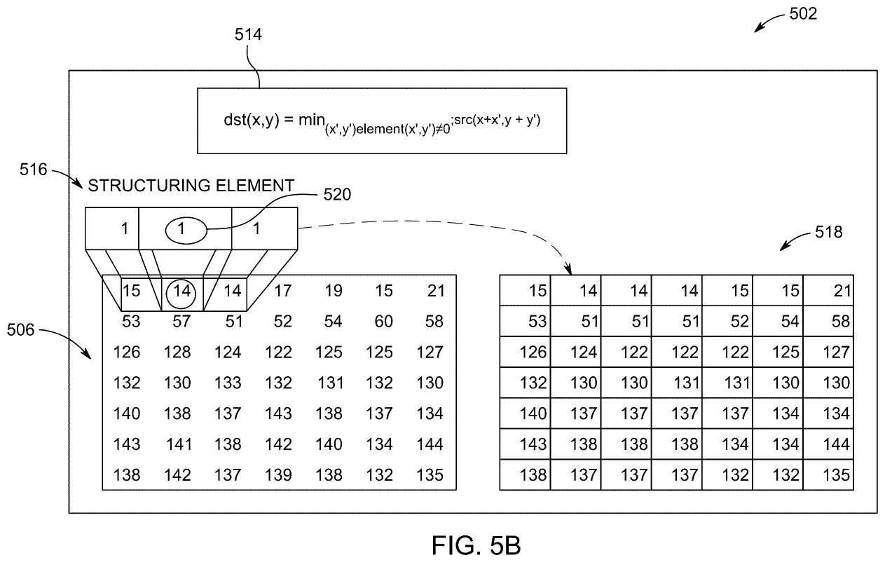

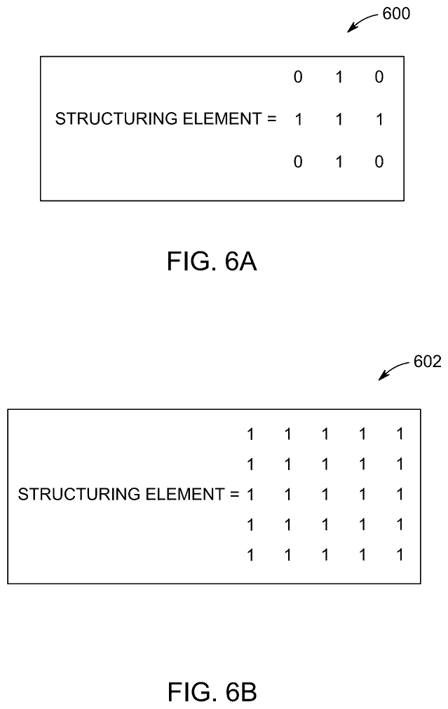

In some embodiments, the Gₓ and G_{y} may be subjected to the morphological operation. In some embodiments, the Gₓ and G_{y} may be dilated using one or more structuring elements, explained in FIGS. 5A-5B and FIGS. 6A-6B. In an example, the at least one processor 104 may generate the maximum (similar to table 212) using ‘dilatedGₓ’ and ‘dilatedG_{y}’. In an example, the at least one processor may generate the buffer (similar to table 212) using the formula:

$$max {DilatedG}_{xy} ( x , y ) = max ( {DilatedG}_{x} ( x , y ) , {DilatedG}_{y} ( x , y ) )$$

Further, in some embodiments, the at least one processor 104 may mark one or more of the plurality of absolute pixel gradients as zero using the formula: maxDilatedG_{xy} thres(x, y)=if maxDilatedG_{xy} thres(x, y)>20 then 0 else maxDilatedG_{xy} (x, y). In an example, for an 8-bit depth image, the at least one processor 104 may be configured with threshold value of 20 as maximum of the plurality of absolute pixel gradients corresponding to a potential color banding area in the input image. In some embodiments, the threshold value may be variable according to one or more parameters of the input image.

In some embodiments, one or more boundary conditions may be implemented on the plurality of absolute pixel gradients of the X-direction buffer and the plurality of absolute pixel gradients of the Y-direction buffer. In an example, for plurality of absolute pixel gradients in X-direction buffer, for last column of the X-direction buffer, the subsequent column (i.e. pixel value) may not be available, hence the plurality of pixel values in the subsequent column may be considered as ‘zero’, which is referred as absolute X-gradient boundary condition. Similarly, for plurality of absolute pixel gradients in Y-direction buffer, for last row of the Y-direction buffer, the subsequent row (i.e. pixel value) may not be available, hence the plurality of pixel values in the subsequent row may be considered as ‘zero’, which is considered as absolute Y-gradient boundary condition.

In an example, the at least one processor 104 may be configured to create a histogram 232 (FIG. 2H) using the buffer of table 230. In an example, the histogram 232 may include an X-axis 234 representing the plurality of pixel values and a Y-axis 236 representing count of the plurality of pixel values. In an example, when the input image is an 8-bit image, the plurality of pixel values ranges 0-255 are plotted on the X-axis of the histogram 232, as shown in FIG. 2H. Further, the count of each of the plurality of pixel values are plotted on the Y-axis, as shown in FIG. 2H.

In an example, a buffer of table 230 is shown in FIG. 2G, comprising maximum of plurality of absolute pixel gradients in X-axis direction and plurality of absolute pixel gradients in Y-axis direction of the input image 200. Further, the plurality of maximum absolute pixel gradient values are plotted in the histogram 232 of FIG. 2H. In some embodiments, the histogram 232 may be computed from maximum absolute pixel gradients of the plurality of absolute pixel gradients in the X-direction buffer and the plurality of absolute pixel gradients in the Y-direction buffer (e.g. MaxGxGy buffer). The histogram 232 includes the X-axis 234 as the plurality of absolute pixel gradients and the Y-axis 236 as the count of each of the plurality of absolute pixel value gradients. In an example, as shown in the histogram 232, at least one of the plurality of absolute pixel value gradients i.e. value 3 is present 14 times in the buffer of table 230. Further, at least one of the plurality of absolute pixel value gradients i.e. value 2 is present 12 times in the buffer of table 230, value 1 is present 11 times in the buffer of table 230 etc.

In some embodiments, the at least one processor 104 may determine the dynamic threshold value using one or more distribution functions (e.g., probability distribution function and cumulative distribution function). The one or more distribution functions are further determined using the histogram of MaxGₓG_{y} buffer. In an example, as shown in FIG. 2I, the at least one processor 104 may generate a probability distribution function (Pdf) to calculate the dynamic threshold value. In some embodiments, the probability distribution function (PDF) may be determined using the formula: Pdf=Histogram (x)/(width*height) as represented by the graph 238. In the graph 238, the X axis 240 represents MaxGₓG_{y} and Y axis represents PDF(x)=probability(x).

In some embodiments, the at least one processor 104 may be configured to generate a cumulative distribution function (CDF) as shown in FIG. 2J using the Pdf. In an example, CDF may be determined by the at least one processor 104 to analyze the distribution of the plurality of absolute pixel gradients across the input image, accurately based on the overall characteristics of the input image. In an example, the cumulative distribution function (CDF) may be determined, via the at least one processor 104, via formula:

$$[ cdf ( x ) = {\int }_{0}^{x} pdf ( x ) dx or {\sum }_{0}^{x} pdf ( x ) ] .$$

As shown in FIG. 2J, the graph 244 represents the cumulative probability distribution of maxGₓG_{y} also referred as CDFGₓG_{y}. Further, the at least one processor 104 may determine the dynamic threshold value using CDFGₓG_{y}, wherein in an example, the at least one processor 104 may be configured to start an index 5 till 20 of CDFGₓG_{y}. until cumulative sum of 5% of the total area of the input image is achieved. In some embodiments, values 5, 20, and 5% may be user defined. The determined index corresponds to the dynamic threshold value (DT). In an example, for an 8-bit depth image, the DT may be in the range of 5 and 20 that may act as boundary between potential color banding areas (low gradient areas) and non-potential color banding areas (high gradient areas). Further, in some embodiments, the at least one processor 104 may perform dilation operations on the buffer generated using the plurality of absolute pixel values in the X-axis direction and the Y-axis direction. Further the at least one processor 104 may perform the dilation operations using a structuring element as specified in FIG. 6A (dilation operations shown in FIG. 5A). Upon performing the dilation operations, subsequent buffer of maxDilatedGₓG_{y}. Further, the at least one processor 106 may determine the maxDilatedGₓG_{y}_thres threshold that contributes in determining the color banding index.

In an example, the potential color banding (CB) area (x,y) may be defined by the formula: potential CB area (x, y)=if min(Gx(x, y), Gy(x, y))<DT, then 255 else 0. In an example, the buffer corresponding to potential color banding area may include values 255. The buffer may be created by applying the negative thresholding method using minimum of Gₓ and G_{y} buffers. Further, the values of the buffer corresponding to 255 may be potential color banding areas and the values of the buffer corresponding to 0 may be non-color banding areas. In some embodiments, the potential color banding (CB) area may be defined as R={min(Gx(x,y), Gy(x,y))<DT}; where ‘R’ is a buffer. The pixel in the buffer ‘R’ at (x,y) location is potential banding area otherwise non-banding area.

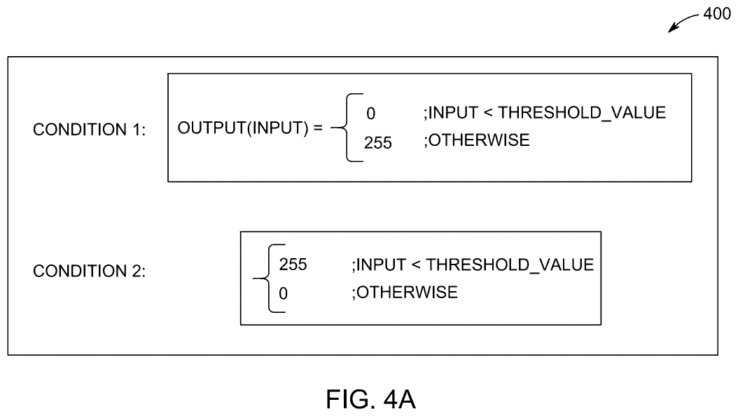

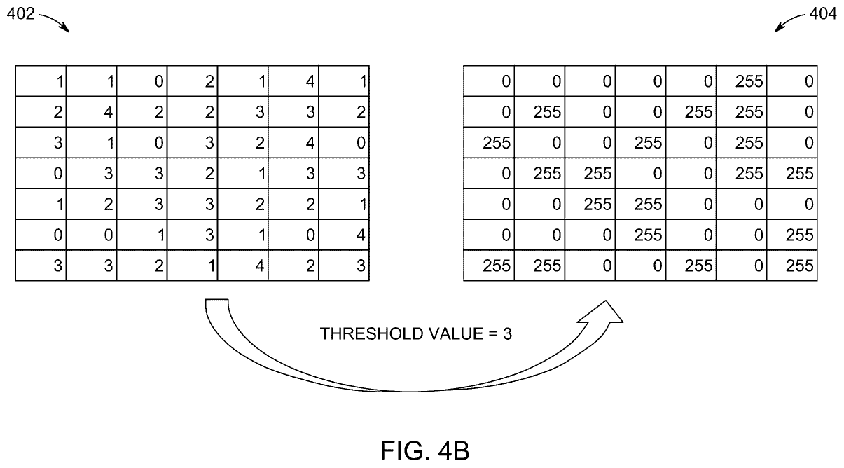

In some embodiments, the at least one processor 104 may use the buffer (generated using the plurality of absolute pixel gradients in X-axis direction and Y-axis direction) to identify plurality of potential color banding areas based on the dynamic threshold value. In an example, the at least one processor 104 may identify the plurality of potential color banding areas by using a positive thresholding method (condition 1 or FIG. 4A) or a negative thresholding method (condition 2 of FIG. 4A) as explained in FIGS. 4A-4B.

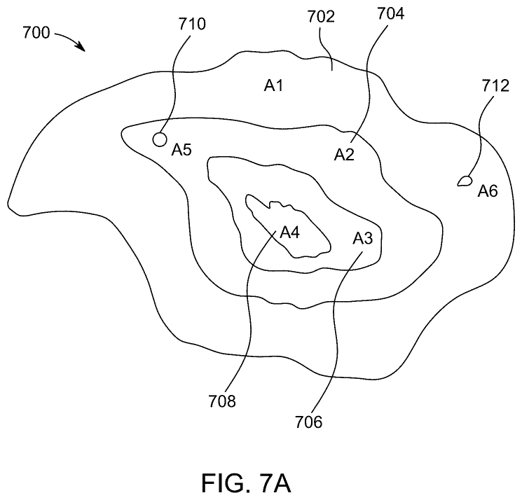

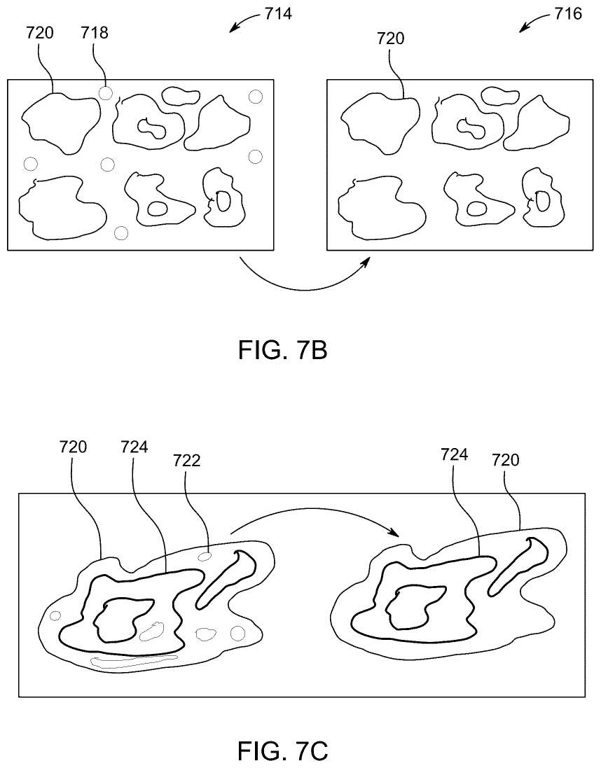

In some embodiments, the at least one processor 104 may determine a plurality of contours 700 (shown in FIG. 7) within the plurality of potential color banding areas based on one or more conditions. In some embodiments, the plurality of contours 700 are defined as closed area of pixels that are having the same intensity. In some embodiments, the plurality of contours 700 corresponds to plurality of acceptable parent contours and plurality of acceptable sub-contours that are determined, via the at least one processor 104, based on the one or more conditions. The plurality of parent contours comprises plurality of pixels' locations which may be marked with 255 after application of threshold over the minimum absolute pixel gradient values of the X-direction buffer and the Y-direction buffer of the input image 200. Further, the plurality of sub-contours are closed area within the plurality of parent contours which consists of single pixel value intensity with respect to original image. (i.e. at all pixel locations of one sub-contour have same or single pixel value with respect to original image). In an example, the at least one processor 104 may eliminate plurality of non-acceptable sub-contours and accordingly determine the plurality of parent contours as acceptable parent contours or non-acceptable parent contours.

In some embodiments, the one or more conditions correspond to a contour area threshold, a pixel gradient threshold, unique pixel value count threshold, plurality of internal pixel gradients of the plurality of contours and plurality of external pixel gradient of the plurality of contours.

In some embodiments, the plurality of parent contours may be validated based on the contour area threshold. Further, the plurality of sub-contours extracted from the plurality of parent contours and having a single pixel value corresponds to the input image. Further, the plurality of sub-contours may be validated based on boundary gradients and the contour area threshold. Further, the plurality of parent contours having the plurality of acceptable sub-contours may be validated based on the contour area threshold, and the single pixel value count.

Further, the at least one processor is configured to determine another buffer using the plurality of acceptable parent contours and the plurality of acceptable sub-contours; and eliminate one or more of the plurality of acceptable parent contours and the plurality of acceptable sub-contours with less than a threshold pixel area to obtain a color banding area.

In an example, the at least one processor 104 may determine the plurality of parent contours corresponding to a threshold of more than 2% area of the total area of the input image 200. In some embodiments, value 2% may be user defined. Further, the at least one processor 104 may not process the one or more of the plurality of parent contours with the absolute pixel gradient value of the buffer generated using the plurality of parent contours and sub-contours as almost zero Further, the at least one processor 104 may determine sub-contours having a single pixel value with respect to the input image. Further, the at least one processor 104 may determine the sub-contours having some boundary gradient with an average more than or equal to 1 which is marked as an acceptable sub-contour with the respective absolute pixel gradient value and the input image. In some embodiments, value “1” may be user defined.

Further, the at least one processor 104 may reject the one or more of the plurality of parent contours having combined accepted sub-contours with pixel value count with respect to input image 200 less than 2, otherwise remaining of the plurality of parent contours are accepted. In some embodiments, value ‘2’ may be user defined. Further, the at least one processor 104 may generate a subsequent buffer with the plurality of acceptable parent contours as 255 else 0. Further, the at least one processor 104 may dilate and then erode the subsequent buffer with a 5×5 structuring element 602 for combining nearby one or more of the plurality of parent contours. In some embodiments, the 5×5 structuring element 602 may be defined by the user. Further, the at least one processor 104 may eliminate one or more of the plurality of parent contours or sub-contours based on another threshold i.e. with less than or equal to 400-pixel area, suggesting that area of the input image covered by the remaining of the plurality of parent contours or sub-contours may be the potential color banding areas contributing to a color banding index of the image. In another example, the another threshold i.e. with less than or equal to 400-pixel area may be defined by the user based on resolution of the input image 200.

In some embodiments, the at least one processor 104 may determine a color banding index for the input image using the plurality of contours. In some embodiments, the at least one processor 104 may determine the color banding index based on an average of the absolute pixel gradients within the plurality of acceptable parent contours as 255 combined. In an example, the at least one processor 104 may determine the color banding index based on a total area of the plurality of potential color banding areas, an average of the plurality of internal absolute pixel gradients within the plurality of contours and an average of the plurality of external absolute pixel gradient on a boundary line of the plurality of contours.

In some embodiments, the color banding index may be determined using a set of equations,

$$PC [ i ] = {i}^{th} acceptable Parent contour within the image ,$$

$$SC [ i , j ] = {j}^{th} acceptable Sub - contour within PC [ i ] ,$$

$${N}_{SC} [ i ] = number of acceptable sub - contours in PC [ i ] ,$$

$$U [ i ] = set of unique pixels within SC [ i , j ] of PC [ i ] = \{ x \vert x is pixel value of SC [ i , j ] ∀ 1 \leq j \leq {N}_{SC} [ i ] \} , \vert U [ i ] \vert = number of elements in set U [ i ] ,$$

$$V [ i ] = Variation Level of PC [ i ] = \frac{\vert U [ i ] \vert}{255} , \\ for 8 - bit image ( adjusted according to bit - depths ) ,$$

$$GL [ i , j ] = Gradient Level of SC [ i , j ] = mean of \{ g ( x , y ) \vert g ( x , y ) is the maxDilatedGxGy\_thres ( x , y ) > th ∀ ( x , y ) ϵ SC [ i , j ] \} , where th is set as 0 and$$

$$PGL [ i ] = Parent Gradient Level of PC [ i ] = {\sum }_{j = 1}^{{N}_{SC} [ i ]} GL [ i , j ]$$

Further, the color banding index is determined by

$$BI [ i ] = Banding Index of PC [ i ] = PGL [ i ] * \frac{V [ i ]}{∝}$$

where ∝ is experimentally set as 20, herein the value ‘20’ may be user defined.

$$A = total area covered by all PC [ i ] where 1 \leq i \leq {N}_{PC} ,$$

where N_{PC} is the total number of acceptable parent contours found within the image,

$$Banding Index of Image B ( 0 - 100 ) = min [ 1 , \frac{A}{H \times W} * \frac{{\sum }_{i = 1}^{{N}_{PC}} BI [ i ]}{{N}_{PC}} ] * 100.$$

In an example, the at least one processor 104 may use the subsequent buffer with the plurality of acceptable parent contours as 255, as the potential color banding areas. Further, the at least one processor 104 may eliminate one or more of the plurality of acceptable parent contours or potential color banding areas having less than 3 unique pixel values with respect to input image 200. In some embodiments, value ‘3’ may be user defined. In an example, less than 3 unique pixel values may correspond to an area in the input image having same color indicating less probable area for color banding whereas more than 3 unique pixel values may correspond to an area in the input image having more colors (or different shades of the same color) indicating high probable area for color banding. Further, the at least one processor 104 may determine the color banding index based on the areas of acceptable contours as the potential color banding areas, an average of the plurality of absolute pixel gradients values within the acceptable contours as the potential color banding areas and an average of the plurality of external absolute pixel gradient values on a boundary line of the acceptable contours as the potential color banding areas.

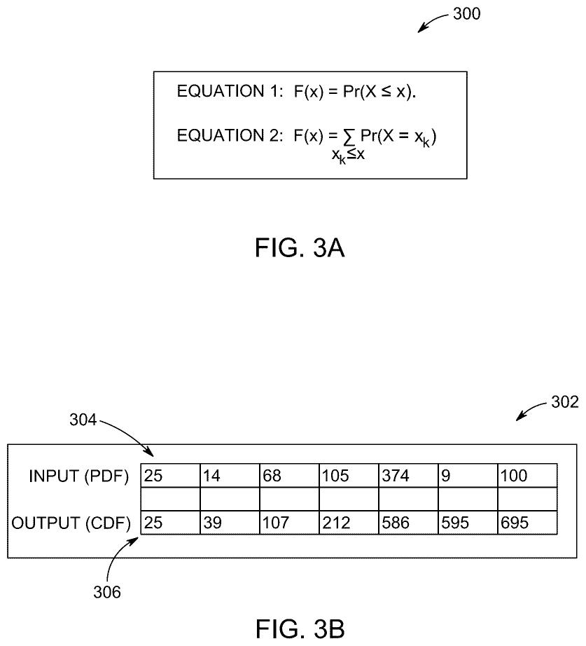

FIG. 3A illustrates equations of a Cumulative Distribution Function (CDF) 300, in accordance with an example embodiment of the present disclosure. FIG. 3B illustrates an output of the CDF 300, in accordance with an example embodiment of the present disclosure.

In some embodiments, the histogram 232 may be computed from maximum absolute pixel gradients of the plurality of absolute pixel gradients in the X-direction buffer and the plurality of absolute pixel gradients in the Y-direction buffer (e.g., MaxGₓG_{y} buffer). In some embodiments, the at least one processor 104 may determine the dynamic threshold value using the histogram of MaxGₓG_{y} buffer. In some embodiments, the at least one processor 104 may generate probability distribution function (PDF) using the histogram of MaxGₓG_{y} buffer. Further, the at least one processor may determine the cumulative distribution function (CDF) to determine the dynamic threshold (DT). In an example, the CDF 300 may be employed by the at least one processor 104 to analyze the distribution of the plurality of absolute pixel gradients across the input image, accurately based on the overall characteristics of the input image.

In an example, the CDF 300 of a discrete random variable X represents the probability that X will take a value less than or equal to x. As described in equations 1 and 2 of FIG. 3A, the CDF output is calculated by summing the probabilities (or values) of all elements up to a certain point (xₖ). In an example, the table 302 shows an input row 304 and an output row 306 of the CFD 300. Further, as shown in FIG. 3B, the input row 304 shows plurality of PDF of histogram of max of absolute pixel gradient values. The output row 306 shows that the first value remains 25, the second value is the sum of first two of the plurality of PDF of histogram of max of absolute pixel gradient values ‘25+14=39’, which continues cumulatively until a last output value is reached. The at least one processor 104 may calculate the CDF 300 of the plurality of PDF of histogram of max of absolute pixel gradient values (similar to the input row 304). The CDF 300 (similar to the output row 306) shows how the plurality of absolute pixel gradient values accumulate. The dynamic threshold value may be where the CDF 300 shows a significant accumulation, indicating a critical transition in data distribution of the input image.

FIG. 4A illustrates a positive thresholding method and a negative thresholding method, in accordance with an example embodiment of the present disclosure. FIG. 4B illustrates an output of the positive thresholding method, in accordance with an example embodiment of the present disclosure. FIG. 4B is described in conjunction with FIG. 4A.

In some embodiments, the at least one processor 104 may be configured to identify a plurality of potential color banding areas based on the dynamic threshold value. The dynamic threshold value may act as a cutoff point to differentiate between regions of the input image with low gradient (which likely exhibit color banding) and those with high gradient (which may not exhibit color banding). Further, in an example, the at least one processor 104 may identify the plurality of potential color banding areas by using a negative thresholding method. In an example, an input matrix such as the buffer may be used comprising a plurality of absolute pixel gradient values. For example, the dynamic threshold value may be applied depending on the range of the plurality of absolute pixel gradient values. In an example, for an 8-bit depth image the negative thresholding method rule may be defined as an instance wherein, if an absolute pixel gradient value is less than the threshold (input <threshold), an output would be 255, otherwise when the absolute pixel gradient value is more than or equal to the threshold (input >=threshold), the output would be 0 (shown as condition 2 in FIG. 4A). The negative thresholding method output may highlight the area of the input image that are below the threshold. For example, the negative thresholding method, herein, converts the absolute pixel gradient values below the threshold into white (255) and all others into black (0).

The negative thresholding method output may highlight the area of the input image that are below the threshold. For example, the negative thresholding method, herein, converts the absolute pixel gradient values below the threshold into white (255) and all others into black (0). In some embodiments, for detecting color banding, the at least one processor 104 may employ the negative thresholding method to highlight the absolute pixel gradient values below the threshold that are highly probable for having color banding.

As shown in FIG. 4B, the buffer of table 402 comprising maximum of plurality of absolute pixel gradients in X-axis direction and plurality of absolute pixel gradients in Y-axis direction of the input image. The buffer of table 402 includes plurality of absolute pixel gradients values such as 0, 1, 2, 3 etc. The at least one processor 104 may employ the positive thresholding method of condition 1 over the buffer of table 402. In an example, for an 8-bit depth image, the threshold may be defined as 3. The at least one processor 104 may use the buffer of table 402 as an input and compare, if an absolute pixel gradient value is less than 3 (input <3), the output would be zero (as shown in the table 404), otherwise when the absolute pixel gradient value is more than or equal to 3 (input >=3), the output would be 255 (as shown in the table 404).

FIGS. 5A-5B illustrate morphological operations, in accordance with an example embodiment of the present disclosure. FIGS. 6A-6B illustrate a structuring element, in accordance with an example embodiment of the present disclosure.

In some embodiments, the at least one processor 104 may perform the morphological operation on the buffer using one or more structuring elements. In an example, the morphological operation may include dilation 500 and/or erosion 502. In an example, the at least one processor 104 may dilate the buffer using the equation 504 and one or more structuring elements 508. In an example, the one or more structuring elements may be a 3×3 matrix 600 (FIG. 6A) or a 5×5 matrix 602 (FIG. 6B). In some embodiments, the one or more structuring elements include an anchor 512 for dilation and another anchor 520 for erosion. The anchors 512, 520 represent a reference point, around which the one or more structuring element moves over the image during dilation or erosion. In an example, the anchor 512 is set to the center of the structuring element (for example, in a 3×3 or 5×5 matrix, the middle pixel is often chosen as the anchor). The anchor 512 may move over the input image i.e. a buffer of table 506 generated using the input image, with respect to the neighborhood pixel value defined by the elements of the one or more structuring elements 508 (as depicted by equation 504). The output 510 corresponds to the pixels that have been dilated or expanded according to the maximum pixel value observed in the neighborhood.

In an example, a structuring element of dimension 3×3 with all elements as 1 with anchor location at (1,1) i.e., middle of structuring element may be considered. So, if 3×3 structuring element is used, an output buffer contains one row and one column lesser than the input buffer. Thus, in order to get same dimension output buffer, the elements which are unable to be calculated via the morphological operation are copied.

In another example, in case enough elements are available for the one or more morphological operations like for location at (1,1):dilate(1,1)=max(1*inputBuffer(0,0), 1*inputBuffer(0,1), 1*inputBuffer(0,2), 1*inputBuffer(1,0), 1*inputBuffer(1,1), 1*inputBuffer(1,2), 1*inputBuffer(2,0), 1*inputBuffer(2,1), 1*inputBuffer(2,2)). Similarly, Erode (1,1)=min(1*inputBuffer(0,0), 1*inputBuffer(0,1), 1*inputBuffer(0,2), 1*inputBuffer(1,0), 1*inputBuffer(1,1), 1*inputBuffer(1,2), 1*inputBuffer(2,0), 1*inputBuffer(2,1), 1*inputBuffer(2,2)). Thus, for first element, i.e. (0,0) indexed element is outputBuffer(0,0)=inputBuffer(0,0). Similar condition is applicable for the elements which are not able to be computed with the morphological operation like dilation.

FIG. 7A illustrates the plurality of contours 700 within the plurality of potential color banding areas, in accordance with an example embodiment of the present disclosure. FIG. 7B-7C illustrate a plurality of acceptable parent contours 720 and sub-contours 724 within the plurality of potential color banding areas, in accordance with an example embodiment of the present disclosure.

In some embodiments, the at least one processor 104 may determine the plurality of contours 700 within the plurality of potential color banding areas based on one or more conditions. In some embodiments, the plurality of contours 700 correspond to plurality of acceptable parent contours and plurality of acceptable sub-contours that are determined, via the at least one processor 104, based on the one or more conditions. In some embodiments, the one or more conditions correspond to a contour area threshold, a pixel gradient threshold, unique pixel value count threshold, plurality of internal pixel gradients of the plurality of contours 700 and plurality of external pixel gradient of the plurality of contours 700.

In some embodiments, the at least one processor 104 is configured to eliminate one or more of the plurality of parent contours based at least on the one or more conditions to determine the plurality of acceptable parent contours. Further, the at least one processor 104 is configured to determine one or more of the plurality of acceptable sub-contours corresponding to a single pixel value with respect to the input image. Further, the at least one processor 104 is configured to determine another buffer using the plurality of acceptable parent contours and the plurality of acceptable sub-contours; and eliminate one or more of the plurality of acceptable parent contours and the plurality of acceptable sub-contours with less than a threshold pixel area to obtain a color banding area. In some embodiments, the at least one processor 104 may determine the plurality of parent contours corresponding to more than 2% area of the total area of the input image.

In an example, the plurality of contours 700 may include six contours including the parent contour A1 and the plurality of contours 702 (A1), 704 (A2), 706 (A3), 708 (A4), 710 (A5), 712 (A6). In an example, the at least one processor 104 may consider the plurality of contours 702 (A1), 704 (A2), 706 (A3), 708 (A4) as acceptable sub-contours, whereas the sub-contours 710 (A5), 712 (A6) may be unacceptable as area of the sub-contours 710 (A5), 712 (A6) is less than 2% area of the total area of the input image.

Further, the at least one processor 104 may not process the sub-contours 710 (A5), 712 (A6) as their absolute pixel gradient value may be almost zero (in the another buffer). Further, the at least one processor 104 may determine sub-contours having a single pixel value (in the another buffer) with respect to the input image. Further, the at least one processor 104 may determine the sub-contours having some boundary gradient with an average more than or equal to 1 which is marked as an acceptable sub-contour with the respective absolute pixel gradient value and the input image. Hence, the plurality of contours 702 (A1), 704 (A2), 706 (A3), 708 (A4) may be the acceptable sub-contours. Further, the at least one processor 104 may determine the color banding index based on sum of area, internal and boundary gradient's average of the plurality of contours 702 (A1), 704 (A2), 706 (A3), 708 (A4). In an example, as shown in FIG. 7B, the at least one processor may reject one or more contours out of a plurality of parent contours 714 to obtain acceptable parent contours represented as 716. The one or more rejected parent contours 718 may contain almost all gradients, referred as ‘maxDiltaedG_{xy_}thres’ as zero.

Further, in some embodiments, the at least one processor 104 may determine sub contours 722, 724 of the plurality of parent contours 720 with single pixel value with respect to the input image. Further, in an example, if the one or more of the sub-contours 722, 744 corresponds to average of boundary non-zero gradient less than 1, the one or more of the sub-contours 722, 724 may be rejected. In some embodiments, value ‘1’ may be user defined. The rejected sub-contours 722 may not be considered in determining the color banding index.

Further, in an example, the plurality of parent contours 720 with the acceptable sub-contours 724 may correspond to pixel value more than 2 with respect to the input image, else the one or more of the plurality of parent contours 720 may be rejected. Further, the at least one processor 104 may generate a buffer containing the acceptable parent contours 720 of the plurality of parent contours 714 for example, buffer name—‘validParents’. Further, the at least one processor 104 may dilate and further erode the buffer ‘validParents’ using the one or more structuring elements and generate a buffer named—‘combinedParents’. Further, in some embodiments, among the buffer named—‘combinedParents’, the buffer corresponding to pixel area less than or equal to 400 may be rejected for further consideration in determining the color banding index. In some embodiments, value 400 may be user defined. Further, in some embodiments, the at least one processor 104 may create a buffer marked 255 with the accepted contours of the buffer named—‘combinedParents’, else the at least one processor 104 may mark 0, thus creating the buffer named as ‘IndexContributingAreas.

In some embodiments, the at least one processor may use the buffer named as ‘IndexContributingAreas’ to determine the color banding index. In some embodiments, the at least one processor 104 may reject the one or more contours of the buffer named as ‘IndexContributingAreas’ with unique pixel values less than 3 with respect to the input image. In some embodiments, value ‘3’ may be user defined. Further, the at least one processor may determine the color banding index of the acceptable contours 720, 724 with respect to non-zero gradients in the buffer ‘maxDiltaedG_{xy}_thres’ and the unique pixel counts with respect to the input image. In some embodiments, the at least one processor may determine the color banding index by calculating mean of—color banding indices of the acceptable parent contours 720 and percentage area corresponding to the acceptable parent contours 720 with respect to total area of the original image.

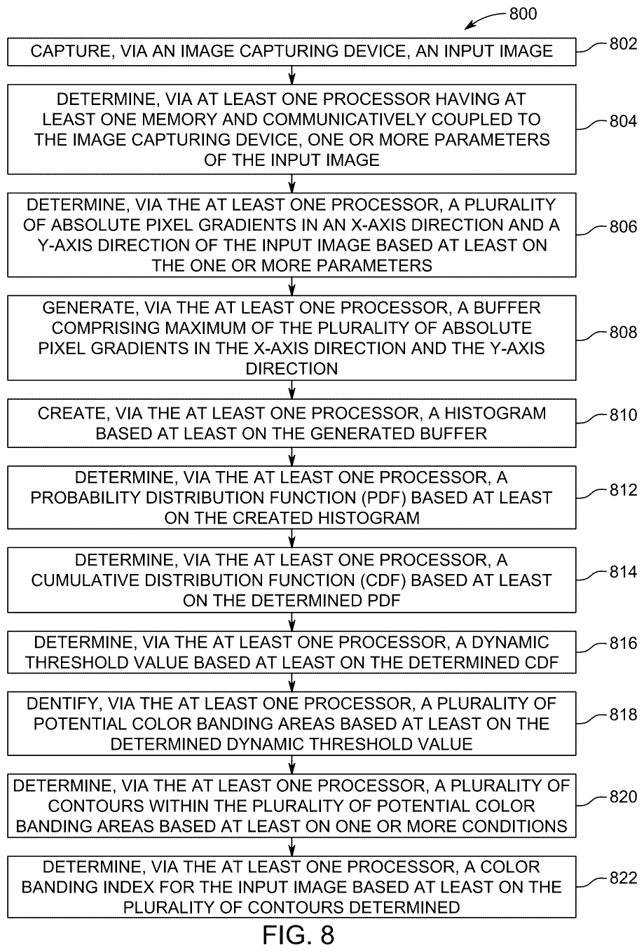

FIG. 8 illustrates a method 800 for detecting color banding, in accordance with an example embodiment of the present disclosure.

At operation 802, the image capturing device 102 may capture an input image. At operation, 804, at least one processor 104 having at least one memory 106 may determine one or more parameters of the input image. In some embodiments, the one or more parameters may correspond to an image size and a plurality of pixel values. In an example, the plurality of pixel values corresponds to numerical representations of intensity or color at each point in the input image. In an example, the input image may be an 8-bit image with the plurality of pixel values ranging from 0 to 255. The at least one processor 104 may be communicatively coupled to the at least one memory 106. Further, the at least one processor 104 may remove plurality of black boundary bars from the input image.

At operation 806, the at least one processor 104 may determine plurality of absolute pixel gradients in an X-axis direction and a Y-axis direction of the input image based at least on the image size and the plurality of pixel values (i.e., one or more parameters). The absolute pixel gradients refer to magnitudes of rate of change in intensity or color of plurality of pixels between one or more neighboring pixels in the input image. In an example, the plurality of absolute pixel gradients in the X-axis direction

$$( \frac{dI}{dx} )$$

may be calculated as difference between intensity of a pixel and the pixel to its right. The plurality of absolute pixel gradients in the Y-axis direction

$$( \frac{dI}{dx} )$$

may be calculated as difference between intensity of a pixel and the pixel below it.

At operation 808, the at least one processor 104 may generate a buffer comprising maximum of the plurality of absolute pixel gradients based on the one or more parameters of the input image i.e. image size and a plurality of pixel values. In an example, the buffer (or the table 230) may correspond to the maximum of the plurality of absolute pixel gradients in the X-axis direction and the plurality of absolute pixel gradients in the Y-axis direction.

At operation 810, the at least one processor 104 may create the histogram 232 using the buffer in the table 230. In an example, the histogram 232 may include an X-axis 234 representing the plurality of pixel values and the Y-axis 236 representing count of the plurality of pixel values. In an example, a buffer as table 230 is shown in FIG. 2G, comprising maximum of plurality of absolute pixel gradients in X-axis direction and plurality of absolute pixel gradients in Y-axis direction of the input image. In an example, the buffer may include plurality of absolute pixel gradients values such as 2, 6, 4, 7, 9 etc. Further, the plurality of maximum of absolute pixel gradient values is plotted in the histogram 232 of FIG. 2H. In an example, as shown in the histogram 232, at least one of the plurality of absolute pixel value gradients i.e. value 2 is present 14 times in the buffer. Further, at least one of the plurality of absolute pixel value gradients i.e. value 6 is present 12 times in the buffer, value 4 is present 11 times in the buffer etc.

At operation 812, the at least one processor 104 may determine a probability distribution function (PDF) based at least on the histogram. In an example, as shown in FIG. 2I, the at least one processor 104 may determine a probability distribution function (PDF) to determine a cumulative distribution function (CDF). The CDF is further used to determine the dynamic threshold value. In some embodiments, the probability distribution function (PDF) may be determined using the formula: Pdf=Histogram(x)/(width*height). as represented by the graph 238. In the graph 238, the X axis 240 represents MaxGₓG_{y} and Y axis represents PDF (x)=probability(x).

At operation 814, the at least one processor 104 may determine the cumulative distribution function (CDF) based at least on the probability distribution function (PDF). In some embodiments, the at least one processor 104 may be configured to determine the cumulative distribution function (CDF) as shown in FIG. 2J using the PDF. In an example, CDF may be determined by the at least one processor 104 to analyze the distribution of the plurality of absolute pixel gradients across the input image accurately based on the overall characteristics of the input image. In an example, the cumulative distribution function (CDF) may be determined, via the at least one processor 104, via formula:

$$[ cdf ( x ) = {\int }_{0}^{x} pdf ( x ) dx or {\sum }_{0}^{x} pdf ( x ) ] .$$

As shown in FIG. 2J, the graph 244 represents the cumulative probability distribution of maxGₓG_{y} also referred as CDFGₓG_{y}. Further, the at least one processor 104 may determine the dynamic threshold value using CDFGₓG_{y}.

At operation 816, the at least one processor 104 may determine a dynamic threshold value based at least on the CDF. In some embodiments, the at least one processor 104 may identify plurality of potential color banding areas based on the dynamic threshold value. The dynamic threshold value may act as a cutoff point to differentiate between regions of the input image with low gradient (which likely exhibit color banding) and those with high gradient (which may not exhibit color banding).

At operation 818, the at least one processor 104 may identify plurality of potential color banding areas based at least on the determined dynamic threshold (DT) value. At operation 820, the at least one processor 104 may determine the plurality of contours 700 within the plurality of potential color banding areas based on one or more conditions. In an example, the at least one processor 104 may identify the plurality of potential color banding areas by using a negative thresholding method. In an example, for an 8-bit depth image, the negative thresholding method rule may be defined as an instance wherein, if an absolute pixel gradient value is less than the dynamic threshold value (input <threshold), an output would be 255, otherwise when the absolute pixel gradient value is more than or equal to the dynamic threshold (input >=threshold), the output would be 0. The negative thresholding method output may highlight the area of the input image that are below the dynamic threshold value, and may include potential color banding.

In some embodiments, the plurality of contours 700 correspond to plurality of acceptable parent contours and plurality of acceptable sub-contours that are determined, via the at least one processor 104, based on the one or more conditions. In some embodiments, the one or more conditions correspond to a contour area threshold, a pixel gradient threshold, unique pixel value count threshold, plurality of internal pixel gradients of the plurality of contours 700 and plurality of external pixel gradient of the plurality of contours 700.

In some embodiments, the at least one processor 104 may determine the plurality of contours 700 (shown in FIG. 7) within the plurality of potential color banding areas based on one or more conditions. In some embodiments, the plurality of contours 700 corresponds to plurality of acceptable parent contours and plurality of acceptable sub-contours that are determined, via the at least one processor 104, based on the one or more conditions. In some embodiments, the one or more conditions correspond to a threshold contour area, a threshold pixel gradient, a threshold pixel value, plurality of internal absolute pixel gradients of the plurality of contours 700 and plurality of absolute external pixel gradient of the plurality of contours 700. In an example, the plurality of potential color banding areas is determined by negative thresholding of minimum of plurality of absolute pixel gradients in the X-axis direction and the Y-axis direction i.e. minGₓG_{y} buffer.

In some embodiments, the at least one processor 104 may determine the plurality of parent contours corresponding to more than 2% area of the total area of the input image. Further, the at least one processor 104 may not process the one or more of the plurality of parent contours with the absolute pixel gradient value as almost zero (in the another buffer). Further, the at least one processor 104 may determine sub-contours a single pixel value (in the another buffer) with respect to the input image. Further, the at least one processor 104 may determine the sub-contours having some boundary gradient with an average more than or equal to 1 which is marked as an acceptable sub-contour with the respective absolute pixel gradient value and the input image. Further, the at least one processor 104 may reject the one or more of the plurality of parent contours having combined accepted sub-contours with pixel value count with respect to input image 200 less than 2, otherwise remaining of the plurality of parent contours are accepted.

At operation 822, the at least one processor 104 may determine a color banding index for the input image based at least on the plurality of contours 700 determined. In some embodiments, the at least one processor 104 may determine the color banding index based on a total area of the plurality of potential color banding areas, an average of the plurality of internal absolute pixel gradients within the plurality of contours 700 and an average of the plurality of external absolute pixel gradient on a boundary line of the plurality of contours 700. In an example, the at least one processor 104 may determine the color banding index based on the areas of acceptable contours as the potential color banding areas, an average of the plurality of absolute pixel gradients values within the acceptable contours as the potential color banding areas and an average of the plurality of external absolute pixel gradient values on a boundary line of the acceptable contours as the potential color banding areas. In some embodiments, the at least one processor 104 is configured to determine the color banding index based on the total area of the plurality of color banding areas, the average of the absolute pixel gradients within the plurality of acceptable parent contours combined.

In some embodiments, the system 100 for detecting color banding is disclosed. The system 100 may comprise an image capturing device 102 configured to capture an input image and at least one processor 104 having at least one memory and communicatively coupled to the image capturing device 102. Further, the at least one processor 104 may be configured to determine one or more parameters of the input image captured by the image capturing device 102, determine a plurality of absolute pixel gradients of the input image based at least on the determined one or more parameters, determine a dynamic threshold value based at least on one or more functions, identify a plurality of potential color banding areas based at least on the determined dynamic threshold value, determine a plurality of contours within the plurality of potential color banding areas based at least on one or more conditions, and determine a color banding index for the input image based at least on the plurality of contours determined.

In some embodiments, the at least one processor 104 may determine the plurality of absolute pixel gradients in an X-axis direction and a Y-axis direction of the input image. Further, the at least one processor 104 may be configured to generate a buffer comprising maximum absolute pixel gradients determined using the plurality of absolute pixel gradients in the X-axis direction and the Y-axis direction, create a histogram based at least on the generated buffer, determine a probability distribution function (PDF) based at least on the created histogram and determine a cumulative distribution function (CDF) based at least on the determined PDF. In some embodiments, the dynamic threshold value may be determined based at least on the determined CDF. In an example embodiment, the one or more parameters of the input image comprises at least an image size and a plurality of pixel values, and the one or more functions may correspond to at least one of the PDF and the CDF.

In some embodiments, the at least one processor may be configured to employ one or more operations on the plurality of absolute pixel gradients in the X-axis direction and the Y-axis direction. The one or more operations may comprise at least one of morphological operations or other gradient techniques.

Embodiments may be configured to detect color banding in an input image e.g. a digital image. Embodiments may be configured to identify high color variation area and low color variation area in the input image, wherein the low color variation area may be highly probable for including color banding. Embodiments may be configured to determine the color banding index of the input image. Embodiments may be configured to detect plurality of pixels clubbed together to form a visible area (concentrated and not randomly distributed color intensity) which may be surrounded by plurality of different pixels grouped together in similar way that may contribute to the color banding. Further, any threshold value used in the various embodiments of the present invention may be altered based on the user requirement.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for detecting color banding, the system comprising:
an image capturing device configured to capture an input image;
at least one processor having at least one memory and communicatively coupled to the image capturing device, wherein the at least one processor is configured to:
determine one or more parameters of the input image captured by the image capturing device;
determine a plurality of absolute pixel gradients of the input image based at least on the determined one or more parameters;
determine a dynamic threshold value based at least on one or more functions;
identify a plurality of potential color banding areas based at least on the determined dynamic threshold value;
determine a plurality of contours within the plurality of potential color banding areas based at least on one or more conditions; and
determine a color banding index for the input image based at least on the plurality of contours determined.

2. The system of claim 1, wherein the plurality of absolute pixel gradients are determined in an X-axis direction and a Y-axis direction of the input image.

3. The system of claim 2, wherein the at least one processor is configured to:
generate a buffer comprising maximum absolute pixel gradients determined using the plurality of absolute pixel gradients in the X-axis direction and the Y-axis direction;
create a histogram based at least on the generated buffer;
determine a probability distribution function (PDF) based at least on the created histogram; and
determine a cumulative distribution function (CDF) based at least on the determined PDF.

4. The system of claim 3, wherein the dynamic threshold value is determined based at least on the determined CDF, and wherein the dynamic threshold value corresponds to a pixel value in correlation with a constant pixel count of the plurality of absolute pixel gradients.

5. The system of claim 3, wherein the one or more parameters of the input image comprises at least an image size and a plurality of pixel values, and wherein the one or more functions correspond to at least one of the PDF and the CDF.

6. The system of claim 2, wherein the at least one processor is configured to remove a plurality of black boundary bars from the input image to determine the plurality of absolute pixel gradients in the X-axis direction and the Y-axis direction.

7. The system of claim 1, wherein the plurality of contours corresponds to a plurality of acceptable parent contours and a plurality of acceptable sub-contours, wherein the at least one processor is configured to:
eliminate one or more of the plurality of parent contours based at least on the one or more conditions to determine the plurality of acceptable parent contours; and
determine one or more of the plurality of acceptable sub-contours corresponding to a single pixel value with respect to the input image.

8. The system of claim 7, wherein the at least one processor is configured to:
determine another buffer using the plurality of acceptable parent contours and the plurality of acceptable sub-contours determined; and
eliminate one or more of the plurality of acceptable parent contours and the plurality of acceptable sub-contours with less than a threshold pixel area to obtain a plurality of color banding areas.

9. The system of claim 2, wherein the at least one processor is configured to employ one or more operations on the plurality of absolute pixel gradients in the X-axis direction and the Y-axis direction, wherein the one or more operations comprise at least one of morphological operations or other gradient techniques.

10. The system of claim 2, wherein the at least one processor is configured to determine a maximum of dilated gradients of the plurality of absolute pixel gradients in the X-axis direction and the Y-axis direction, and wherein the color banding index is based at least on a plurality of acceptable parent contours combined, a plurality of acceptable sub-contours, a plurality of color banding areas, and the maximum of the dilated gradients of the plurality of absolute pixel gradients in the X-axis direction and the Y-axis direction.

11. The system of claim 1, wherein the one or more conditions correspond to a contour area threshold, a pixel gradient threshold, a unique pixel value count threshold, a plurality of internal absolute pixel gradients of the plurality of contours and the plurality of acceptable sub-contours.

12. A method for detecting color banding, the method comprising:
capturing, via an image capturing device, an input image;
determining, via at least one processor having at least one memory and communicatively coupled to the image capturing device, one or more parameters of the input image;
determining, via the at least one processor, a plurality of absolute pixel gradients of the input image based at least on the one or more parameters;
determining, via the at least one processor, a dynamic threshold value based at least on one or more functions;
identifying, via the at least one processor, a plurality of potential color banding areas based at least on the determined dynamic threshold value;
determining, via the at least one processor, a plurality of contours within the plurality of potential color banding areas based at least on one or more conditions; and
determining, via the at least one processor, a color banding index for the input image based at least on the plurality of contours determined.

13. The method of claim 12, wherein the plurality of absolute pixel gradients are determined in an X-axis direction and a Y-axis direction of the input image.

14. The method of claim 13, further comprising:
generating, via the at least one processor, a buffer comprising maximum of the plurality of absolute pixel gradients in the X-axis direction and the Y-axis direction;
creating, via the at least one processor, a histogram based at least on the generated buffer;
determining, via the at least one processor, a probability distribution function (PDF) based at least on the created histogram; and
determining, via the at least one processor, a cumulative distribution function (CDF) based at least on the determined PDF.

15. The method of claim 14, wherein the dynamic threshold value is determined based at least on the determined CDF, and wherein the dynamic threshold value corresponds to a pixel value in correlation with a constant pixel count of the plurality of absolute pixel gradients, and wherein the one or more parameters of the input image comprise at least an image size and a plurality of pixel values, and wherein the one or more functions correspond to at least one of the PDF and the CDF.

16. The method of claim 13, further comprising removing, via the at least one processor, a plurality of black boundary bars from the input image to determine the plurality of absolute pixel gradients in the X-axis direction and the Y-axis direction.

17. The method of claim 12, wherein the plurality of contours corresponds to a plurality of acceptable parent contours and a plurality of acceptable sub-contours, and further comprising:
eliminating, via the at least one processor, one or more of the plurality of parent contours based at least on the one or more conditions to determine the plurality of acceptable parent contours; and
determining, via the at least one processor, one or more of the plurality of acceptable sub-contours corresponding to a single pixel value with respect to the input image.

18. The method of claim 17, further comprising:
determining, via the at least one processor, another buffer using the plurality of acceptable parent contours and the plurality of acceptable sub-contours determined; and
eliminating, via the at least one processor, one or more of the plurality of acceptable parent contours and the plurality of acceptable sub-contours with less than a threshold pixel area to obtain a plurality of color banding areas.

19. The method of claim 12, further comprising employing, via the at least one processor, one or more operations on the plurality of absolute pixel gradients in the X-axis direction and the Y-axis direction, wherein the one or more operations comprise at least one of morphological operations or other gradient techniques.

20. The method of claim 12, further comprising determining, via the at least one processor, a maximum of dilated gradients of the plurality of absolute pixel gradients in the X-axis direction and the Y-axis direction, and wherein the color banding index is based at least on a plurality of acceptable parent contours combined, a plurality of acceptable sub-contours, a plurality of color banding areas, and the maximum of the dilated gradients of the plurality of absolute pixel gradients in the X-axis direction and the Y-axis direction.
